(19) United States
(12) Patent Application Publication
(10) Pub. No.: US 2007/0264074 A1
(43) Pub. Date: Nov. 15, 2007

(54) DISPENSING PACKAGE FOR USE IN TREATING ELONGATED OBJECTS

(76) Inventor: Rebecca DeLegge, Mt. Pleasant, SC (US)

Correspondence Address: B. CRAIG KILLOUGH, P. O. DRAWER H, CHARLESTON, SC, 29402, US

(21) Appl. No.: 11/748,991

(22) Filed: May 15, 2007

Related U.S. Application Data
(60) Provisional application No. 60/800,482, filed on May 15, 2006.

(51) Int. Cl. B05C 11/00; B43M 11/06

(52) U.S. Cl. 401/266; 401/264

(57) ABSTRACT

A dispensing package for use in treating objects is characterized by the capability of exuding a fluid material from the interior of the pack onto the object. The dispensing package has a first layer having a plurality of perforations through which a fluid material may pass and a second layer that is impervious to the fluid material and an intermediate layer disposed between the first and second layers containing a fluid material and exuding same when used.

### CROSS-REFERENCE TO RELATED APPLICATION

The contents of U.S. Provisional Application Ser. No. 60/800,482, filed May 15, 2006, on which the present application is based and benefit claimed under 35 U.S.C. §119(e), is herein incorporated by reference.

### BACKGROUND OF THE INVENTION

1. Field of the Invention

The present invention relates generally to a dispensing package for treating elongated objects such as medical instruments. More specifically, the invention relates to a dispensing package characterized by the capability of exuding a fluid material from the interior of the dispensing package onto the instrument.

2. Description of Related Art

Gastroenterologists and other physicians performing surgical or other clinical procedures use lubrication to pass instruments or device into the patient. The physician squeezes a tube (like a toothpaste tube or a small packet) of lubrication (like SURGILUBE™ or KY jelly) onto a sponge or finger or upon the instrument or device to be placed or used. A dollop of lubrication may be placed on one side a the sponge or instrument, and a sponge or gauze is used to spread the lubrication to the rest of the instrument or visualizing scope, which may have a circular cross section.

A consequence of this lubricating method is that the lubrication often spreads from the instrument to the doctor's or nurse's gloves and onto the patient, the bed, the linens, the floor, the telephone, and other medical equipment in the room. Often the application of lubrication is placed on a 4×4 inch square of gauze or sponge that is available on the patient's procedure stretcher, or a Mayo stand near the patient. This positioning is a convenience, so that the physician can grasp and use the gauze or sponge to apply additional lubrication to the instruments during the procedures as the instruments “dry out.” Occasionally, the gauze or sponge becomes lost in the bed linen, underneath the patient, in the packaging of other surgical instruments, or falls onto the floor, creating a safety hazard. In addition, the doctor often uses the same tube of lubrication from patient to patient, or from procedure to procedure in the same patient, such that if he/she touches the tube during one procedure there is a risk of cross contamination during a second or third procedure. The tube serves as a nidus for infection. The described process has been an accepted practice for an extended period of time. Individual packets of lubricants generally have not been used because they have a small volume of lubricant, are difficult to open, are not cost-effective and are not the answer to the problem.

Thus, it can be readily seen that there is a need for a way to treat elongated objects, especially medical instruments that uses an individually packaged material such as a lubricant or disinfectant and, if required, is sterilized.

### SUMMARY OF THE INVENTION

It is an object of the invention to provide an easy to use disposable dispensing package for lubricating or otherwise treating an elongated object, such as a medical instrument.

In one embodiment of the present invention there is provided a dispensing package including a lower layer which is preferably liquid impervious. The dispensing package also comprises a fluid material. The fluid material may be contained in a bladder or it may be an impregnate that is impregnated in an absorbent material capable of retaining and exuding a fluid material. The fluid material may be present within a package formed by the lower layer, and in another embodiment, between an upper and lower layer. The dispensing package is adapted to exude the fluid material during use. The upper layer may have a plurality of perforations formed therein to enable the fluid material contained in intermediate layer to exude there through when the dispensing package is squeezed. The first layer and/or the second layer may be sealed at their edges forming a unitary fluid material-containing dispensing package. The dispensing package is deformable to surround the elongated object to be treated. In another embodiment of the present invention, the device may be preformed into a “C” shape.

The device may be packaged in a variety of ways. For example, an impervious peel away covering may be placed over the plurality of perforations material or over first layer and sealed at the edges. Another way in which the dispensing package may be protected is to place it in a pouch or other barrier material that retards drying of the fluid material. The user of the dispensing package simply removes the pack from its packaging and places it around the object to be treated. The fluid material is released by applying pressure to, or squeezing, the dispensing package, or the dispensing package may be filled with fluid material such that the fluid material exits the dispensing package freely. The dispensing package is then simply swiped along the instrument to provide the lubrication or other treatment. The dispensing package is disposable and may be discarded after completion of the procedure.

Other object, features and advantages of the present invention will become apparent from the following detailed description of the invention taken in conjunction with the accompanying drawings.

### BRIEF DESCRIPTION OF THE DRAWINGS

Having described the invention in general terms, reference will now be made to the accompanying drawings, which are not necessarily drawn to scale, and wherein:

FIG. 1 is an exploded perspective view of the dispensing package embodying the features of the present invention;

FIG. 2 is a perspective view of the dispensing package shown in FIG. 1:

FIG. 3 is a fragmentary, enlarged perspective view of the upper layer of the dispensing package shown in FIGS. 1 and 2;

FIG. 4 is an enlarged fragmentary sectional view taken substantially along line 4-4 in FIG. 2;

FIG. 5 is a perspective view of the dispensing package of the present invention being used to treat a medical instrument;

FIG. 6 is an enlarged view of another embodiment of the present invention showing the dispensing package in a packaged form;

FIG. 7 is a perspective view of another embodiment of the present invention showing the dispensing package in a preformed “C” shape;

FIG. 8 illustrates a packaging embodiment for the invention;

FIG. 9 is another embodiment of the present invention showing the dispensing package as a fragmentary sectional view;

FIG. 10 is another embodiment of the present invention showing the dispensing package as a fragmentary sectional view;

FIG. 11 is an elevation of a side of an embodiment of the present invention;

FIG. 12 is an embodiment of the present invention;

FIG. 13 shows the embodiment of the invention of FIG. 12 with a peel away strip mounted on the device;

FIG. 14 is a side elevation of the embodiment of FIG. 13; and

FIG. 15 shows a plurality of the devices according the present invention joined by perforations.

### DESCRIPTION OF THE PREFERRED EMBODIMENT(S)

The present invention now will be described more fully hereinafter with reference to the accompanying drawings, in which preferred embodiments of the invention are shown. This invention may, however, be embodied in many different forms and should not be construed as limited to the embodiments et forth herein; rather these embodiments are provided so that this disclosure will be through and complete and will fully convey the scope of the invention to those skilled in the art. Like numbers refer to the elements throughout.

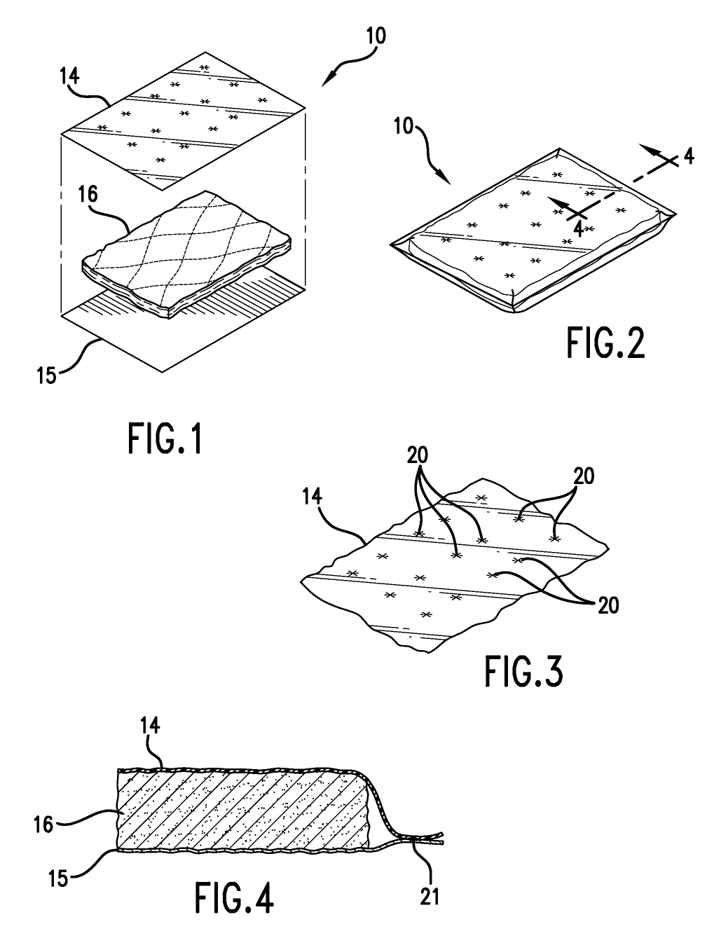

Referring more specifically to the drawings, there is shown in FIG. 1 a first embodiment of the dispensing package 10 embodying the features of the present invention. The dispensing package of this embodiment includes an upper layer 14, preferably a liquid impervious plastic material, such as a polyolefin based plastic film, e.g., polyethylene, or release coated paper, e.g., cellophane silicone coated paper, or a foil, and a lower layer 15 which is preferably liquid impervious. The dispensing package 10 also includes an intermediate layer 16 comprising an absorbent material capable of retaining and exuding a fluid material, which is disposed between the upper and lower layers 14 and 15. The dispensing package is adapted to exude a fluid material during use.

As shown in FIG. 3, the upper layer 14 has a plurality of perforations 20 formed therein to enable the fluid material contained in intermediate layer 16 to exude there through when the package is squeezed. Because the lower layer 15 is impervious to the fluid material the user's hands do not become covered with the fluid material.

Intermediate layer 16 comprises an absorbent material capable of retaining and exuding a fluid material. The absorbent material may be cellulosic materials such as a sponge or absorbent fibers, such as a non-woven material. It will be understood by those skilled in the art that equivalent absorbing materials may be used.

Various fluid materials may be included in or on intermediate layer 16. Such fluid materials include lubricants, such as SURGILUBE™ or KY jelly and disinfectants such as bactericides, like potassium sorbate. The fluid material may be sterile, and the associated packaging according to the invention may provide a sterile environment for the fluid material until ready for use. Most fluid materials may be used, but viscous materials that are gels or jelly like are preferred.

The upper layer 14 and lower layer 15 may extend beyond the periphery of intermediate layer 16 and be secured together at their edges around the periphery of the intermediate layer 16 as indicated in FIG. 4 at 21, such as by an adhesive such as a hot melt adhesive. The adhesive securement does not significantly interfere with the exuding action of the dispensing package when in use and will prevent any fluid material from leaking out of the pad.

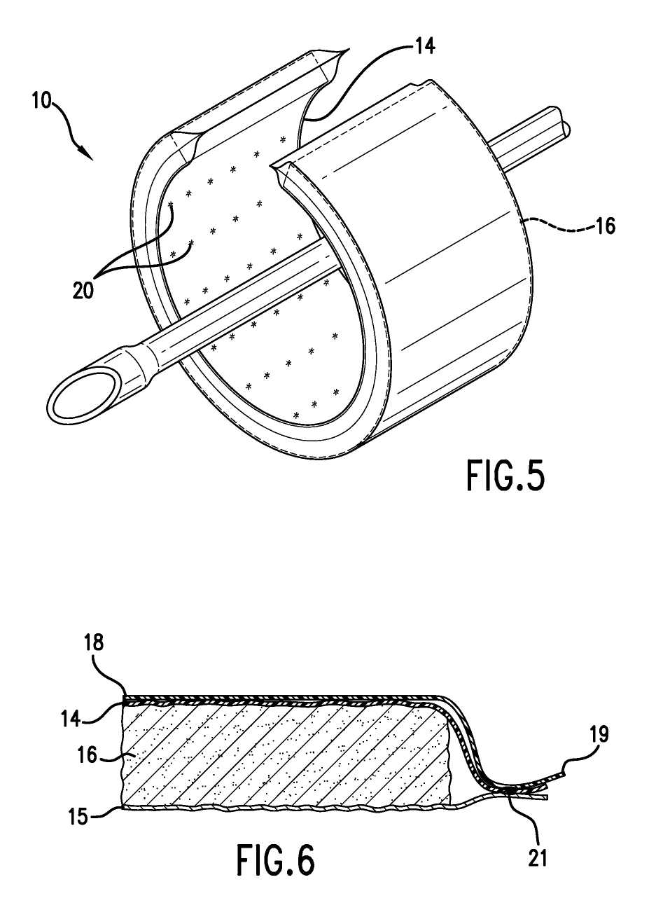

The user of the dispensing package removes the pack 10 from its packaging and places it around the instrument to be treated as shown in FIG. 5. The fluid material is released by applying pressure to, or squeezing, the dispensing package, or the dispensing package may be filled with fluid material such that the fluid material exits the dispensing package freely. The dispensing package is then simply swiped along the instrument to provide the lubrication or other treatment. It should be understood that the dispensing package may be used to lubricate other elongated objects, including a physician's finger. The dispensing package is disposable and may be discarded after completion of the procedure.

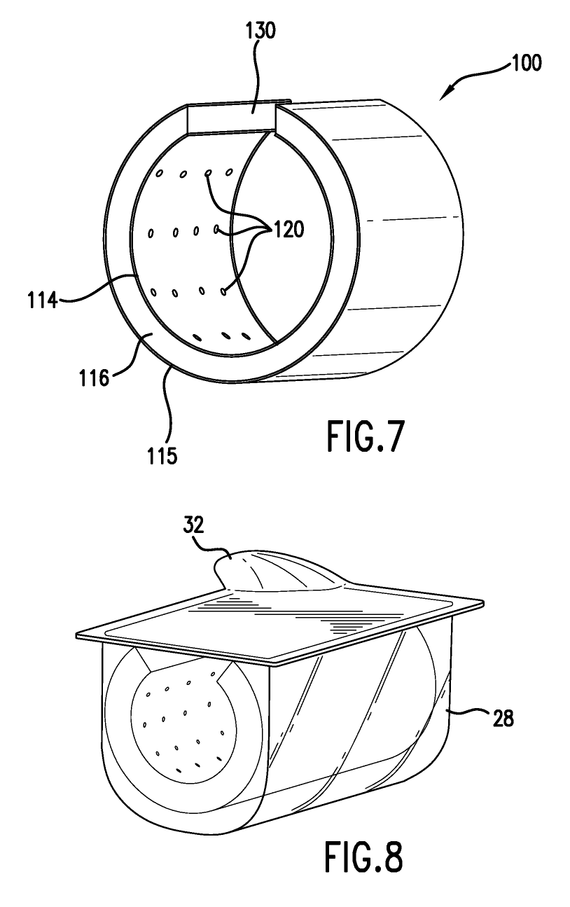

As noted, the dispensing package may take various shapes. One shape, particularly useful in gastroenterology, is to form the dispensing package in a “C” shape as shown in FIG. 7. The endoscopist may leave the dispensing package at the top of the instrument during the procedure, and remove the dispensing package if necessary through the opening in the “C”. The “C” shape allows the dispensing package to be easily moved from the endoscope and used for another piece of equipment for the same patient. The “C” shape also allows the dispensing package to be stored at the top of the instrument, and out of the way of the procedure, and moved down the instrument for re-treatment as necessary. The dispensing package of this invention makes fluid material loss negligible, and avoids application of the fluid material to undesirable locations.

As shown most clearly in FIG. 7, the “C” shaped dispensing package 100 is a generally circular embodiment having a central void 110, with a slit 130 in one side that communicates with the central void and the exterior of the dispensing package. The dispensing package may include an inner layer 114 and an outer layer 115. Disposed between the inner layer and the outer layer is liquid material containing intermediate layer 116, which may either form a bladder or include an absorbent material. This embodiment may be formed similarly to the embodiments shown in FIGS. 1-4, 6, or 9-10.

The elongated object to be treated may be placed through the slit 130 and pushed through the central void. The central void then traverses the elongated object to treat it. The fluid material whether a lubricant, a disinfectant or the like, is available in the central void in this embodiment, while no fluid material is on the outside of outer layer 115, so that the dispensing package may be gripped along the outer layer 115. The device may be formed in other shapes that provide an internal void that traverses the elongated object, either having, or not having, a slit that communicates with the internal void and the outside of the outer layer 115.

The dispensing package 10 may be packaged in a variety of ways. Typically, the fluid material will not prematurely exude from the intermediate layer on its own but depending upon the viscosity of the fluid material it may be desirable to affix an impermeable cover 18 over the upper layer 14 and sealed at the edges to retain sterility as shown in FIG. 6. When ready for use, the cover is removed by pulling on peel tab 19.

Another way in which the dispensing package may be protected is to place it in a pouch or other barrier material that retards drying. Various means for opening the pouch are well known to those skilled in the art. The dispensing package described in FIG. 7 may be packaged individually such as shown in FIG. 8.

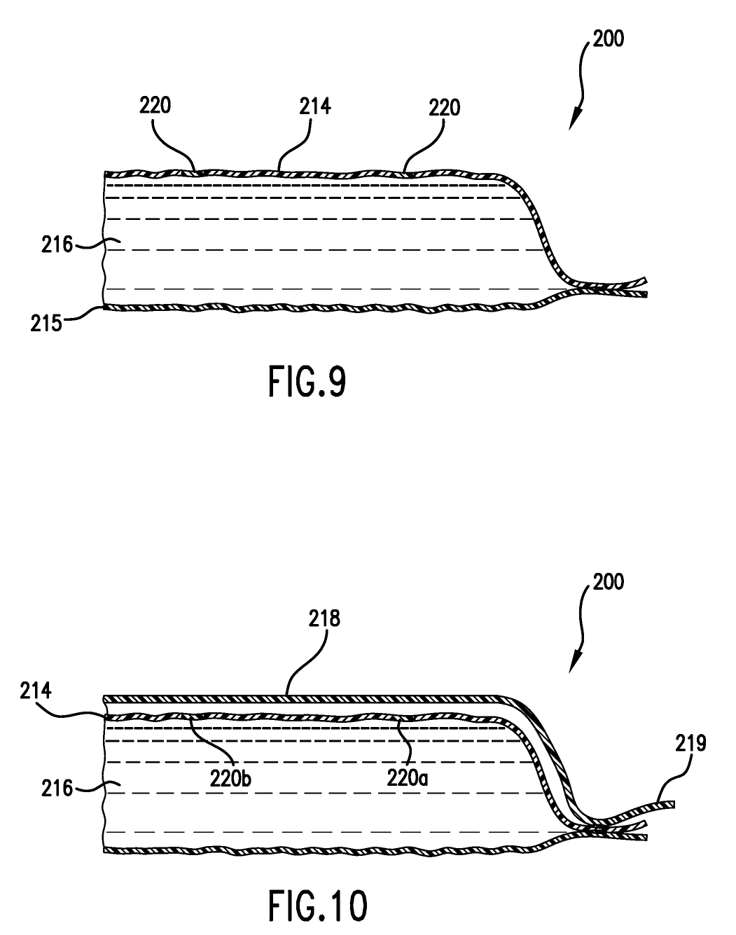

FIG. 9 shows a dispensing package 200 as a bladder in which a liquid material is contained and from which the liquid material is subsequently dispensed. The bladder may be formed in various ways, but is preferably formed of a liquid impervious material. In one embodiment, an upper layer 214 is bonded to a lower layer 215. The bladder must surround and contain the liquid material 216.

One surface of the bladder has a plurality of orifices 220 therein. As shown in FIG. 9, the orifices are formed of a material that will burst when pressure is applied to the bladder. For example, when the bladder is folded around an elongated object to be treated with the liquid material, then manually squeezed against the elongated object, pressure within the bladder and against the bladder walls is increased. The orifices are formed to burst open when the pressure rises to a predetermined level, releasing the liquid material from one side of the bladder, which is the side against which the elongated object traverses.

In another embodiment, the orifices 220b are either formed as open in the bladder or the orifices 220a may be formed as closed of a material that will burst when pressure is applied to the bladder. FIG. 10. In this embodiment, an impermeable cover 218 is over the upper layer 214 and sealed at the edges to retain sterility. The cover will retain, or assist in retaining, the liquid in the bladder so that the liquid does not prematurely escape from the bladder. When ready for use, the peel tab is pulled away from the top layer such as by pull tab 219.

The embodiment of FIG. 9 or FIG. 10 may be formed as a flat, but foldable, device, or as a preformed C shape. The upper layer has a generally flat top planar surface having a plurality of perforations therein.

FIG. 8 shows a package 28 for the device, with a pull tab 32 for a top cover in place.

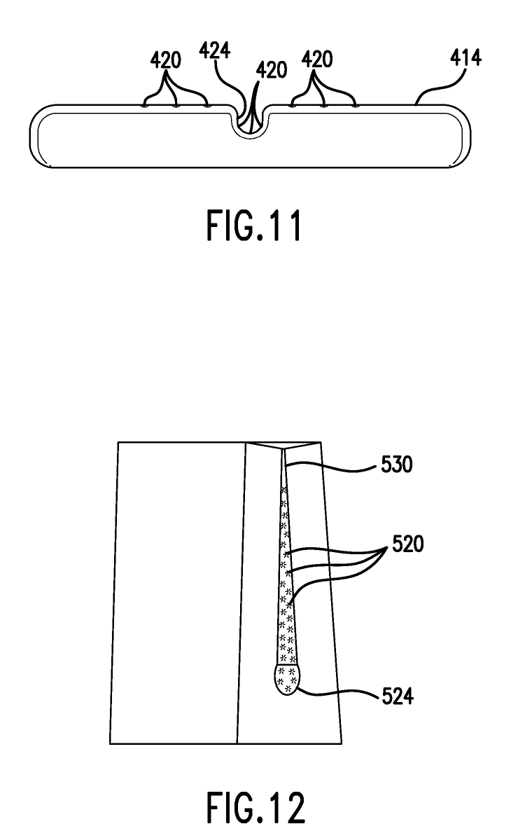

FIG. 11 shows the device in a flat position. The device as shown may be formed according to the descriptions herein. The top layer 414 is generally flat and has perforations 420 formed therein. A semi-annular relief area 424 is formed in the top layer for receiving an instrument therein. The device may be folded over an elongated object, with the perforations exuding a liquid material. The perforations may burst under pressure and/or be protected by a peel away strip prior to use.

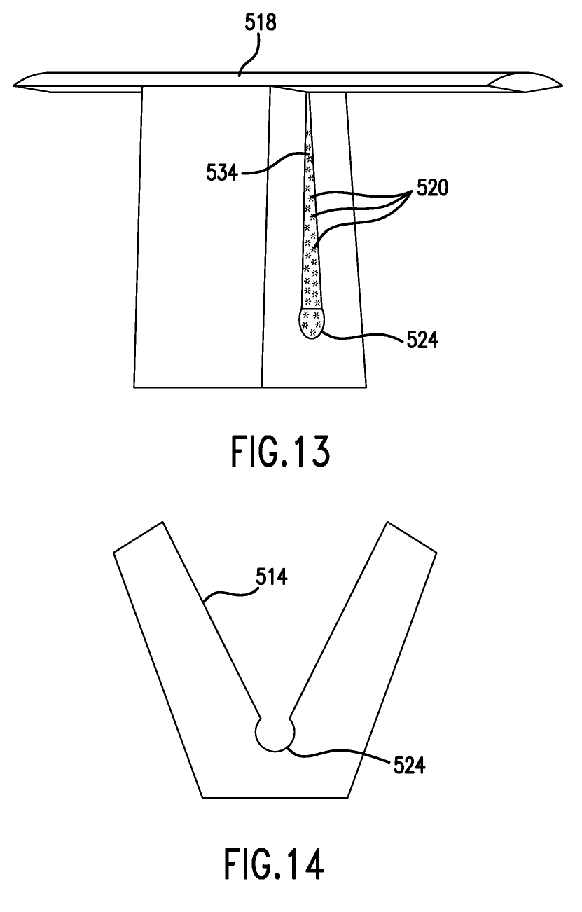

FIG. 12 shows another embodiment of the device. While this embodiment has a different shape than other embodiments, the device may be formed generally according to the descriptions herein. The top layer 514 has perforations 520 formed therein. A semi-annular relief area 524 is formed in the top layer for receiving an instrument therein. The elongated object to be treated may be placed through the slit 530 and pushed through to the semi-annular relief area. FIG. 13. The perforations may burst under pressure and/or be protected by a peel away strip 518 prior to use. The peel away strip may be affixed over the top of the device as shown, and also extend over the slot 534 on each end to cover access to the perforations prior to use, so that a package for the device is completed. The peel away strip is peeled away prior to use. The device is sufficiently flexible to allow it to be manually reformed as shown in FIG. 14, so that the opposing sides are pushed away to allow a large access area to the top layer and the plurality of perforations therein.

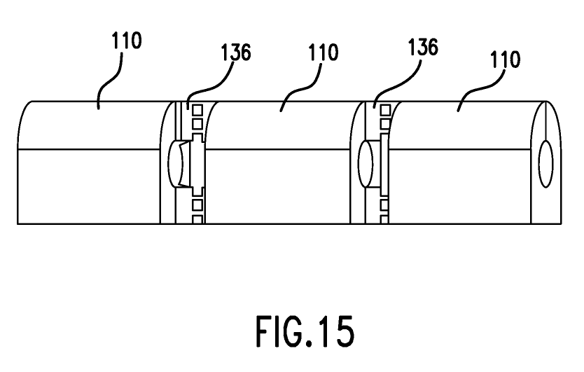

FIG. 15 demonstrates a plurality of the devices connected by perforated material 136 for ease of transport. The devices maybe packaged in a tube and/or dispenser that allows the devices to be sequentially separated as needed for use.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purpose of limitation.

What is claimed is:

1. A dispensing package for use in treating an elongated object characterized by the capability of exuding a fluid material from the interior of said dispensing package onto said elongated object comprising:
a first layer having a plurality of perforations through which a fluid material may pass;
a second layer that is impervious to said fluid material;
an intermediate layer disposed between said first layer and said second layer containing a fluid material and exuding same through said plurality of perforations when used; and
means securing said first and second layers and said intermediate layer together around the periphery thereof to form a seal space outwardly from said intermediate layer without significantly hindering or interfering with the exuding action of said intermediate layer when in use.

2. The dispensing package for treating an elongated object according to claim 1, wherein said dispensing package is deformable to surround an elongated object.

3. The dispensing package for treating an elongated object according to claim 1, wherein said first layer is a polyolefin film.

4. The dispensing package for treating an elongated object according to claim 1, wherein said intermediate layer comprises an absorbent material.

5. The dispensing package for treating an elongated object according to claim 1, wherein said intermediate layer comprise a cellulosic based material.

6. The dispensing package for treating an elongated object according to claim 1, wherein said intermediate layer comprises a sponge.

7. The dispensing package for treating an elongated object according to claim 4, wherein said intermediate layer comprises a non-woven material.

8. The dispensing package for treating an elongated object according to claim 1, wherein said fluid material is a lubricant.

9. The dispensing package for treating an elongated object according to claim 1, wherein said fluid material is a disinfectant.

10. The dispensing package for treating an elongated object according to claim 1, wherein said second layer is a polyolefin.

11. The dispensing package for treating an elongated object according to claim 1, wherein dispensing package is preformed in a “C” shape.

12. The dispensing package for treating an elongated object according to claim 1, wherein said first and second layers are joined around their periphery by an adhesive.

13. The dispensing package for treating an elongated object according to claim 1, wherein said first and second layers are joined around their periphery by heat sealing.

14. The dispensing package for treating an elongated object according to claim 1, further comprising a tear away covering disposed over said plurality of perforations and providing a sterile environment within an interior of said dispensing package.

15. A package for storing a dispensing package for use in treating elongated objects characterized by the capability of exuding a fluid material from the interior of said dispensing package onto said elongated object, said package comprising:
a container for confining said dispensing package;
a dispensing package disposed within or a part of said container, said dispensing package comprising a first layer having a plurality of perforations through which an fluid material may pass and a second layer that is impervious to said fluid material; and
an intermediate layer disposed between said first layer and said second layer containing an fluid material and exuding said fluid material through said plurality of perforations when used; and means securing said first and second layers and said intermediate layer together around the periphery thereof to form a seal space outwardly from said intermediate layer without significantly hindering or interfering with the exuding action of said intermediate layer when in use.

16. The package for storing a dispensing package according to claim 15, wherein said dispensing package is preformed in the shape of a “C” and the outer side of said second layer forms a portion of said package.
